(19) United States
(12) Patent Application Publication
(10) Pub. No.: US 2025/0039326 A1
(43) Pub. Date: Jan. 30, 2025

(54) IMAGE PROCESSING APPARATUS, METHOD FOR PROCESSING IMAGE, AND MEDIUM

(71) Applicant: CANON KABUSHIKI KAISHA, Tokyo (JP)

(72) Inventors: TSUKASA SANO, Kanagawa (JP); TAKUTO MORIGUCHI, Kanagawa (JP); OSAMU YOSHITAKE, Chiba (JP); HIROSHI TOMIOKA, Tokyo (JP)

(21) Appl. No.: 18/781,809

(22) Filed: Jul. 23, 2024

(30) Foreign Application Priority Data
Jul. 28, 2023 (JP) 2023-123788
Aug. 30, 2023 (JP) 2023-140543

(51) Int. Cl. H04N 1/60

(52) U.S. Cl. CPC H04N 1/6086; H04N 1/6019; H04N 1/6097

(57) ABSTRACT

An image processing apparatus according to the present disclosure includes an input unit configured to input image data and a color conversion unit configured to, based on a time-dependent color variation characteristic of a printed image in a first recording medium, perform color conversion on the image data corresponding to time-dependent color variation of a second recording medium.

### BACKGROUND

### Field

The present disclosure relates to color conversion processing in which time-dependent color variation is considered.

### Description of the Related Art

In various method of recording an image such as an inkjet method, an electrophotographic method, and various offset methods, a time-dependent color variation phenomenon may occur. In this phenomenon, a color immediately after printing and a color after a certain time has passed differ from each other. To accommodate such a phenomenon, calibration is performed. In the calibration, a color chart is recorded with a printing apparatus and subjected to colorimetry with a measurement device. An image processing parameter such as a color conversion table is created or updated in accordance with the difference between a measured colorimetry value and a target color or density to be output.

Meanwhile, in the calibration, when the chart is recorded, time taken to stabilize the density or color of the chart may be long. For this reason, when the colorimetry is performed immediately after recording of a patch, a result of the colorimetry does not necessarily indicate an actual recording characteristic of a recording apparatus at this time. This may result in an image processing parameter having been updated by the calibration being inappropriate. Also, it is known that the time taken to stabilize the density or color may largely vary depending on printing media and types of ink sets.

Japanese Patent Laid-Open No. 2013-56468 discloses a technique of setting a target density value of an objective printing medium after detection of standby time (color stabilization time) taken to stabilize color variation of an image recorded in the printing medium. Japanese Patent Laid-Open No. 2016-184902 discloses a technique of monitoring color variation of a limited subset of colors in an entire color gamut reproduced by an image forming apparatus to predict color variation of the entire color gamut.

Although appropriate calibration can be executed by setting the standby time for the time-dependent color variation corresponding to the printing medium according to the method disclosed in Japanese Patent Laid-Open No. 2013-56468, it is required to wait for a time corresponding to the standby time. According to the method disclosed in Japanese Patent Laid-Open No. 2016-184902, it is difficult to continue monitoring in the apparatus in the case of a printing medium requiring a comparatively long time until the density or the colors are stabilized, for example, in the case of a printing medium requiring a few days to a week until the colors are stabilized. Thus, in some cases, it is required to wait for a long time.

### SUMMARY

In view of the above-described problem, an image processing apparatus according to the present disclosure includes one or more circuits; or one or more processors and at least one memory, the at least one memory being coupled to the one or more processors and having stored thereon instructions executable by the one or more processors, wherein at least one of the one or more circuits or the execution of the instructions causes the image processing apparatus to function as: an input unit configured to input image data and a color conversion unit configured to, based on a time-dependent color variation characteristic of a printed image in a first recording medium, perform color conversion on the image data corresponding to time-dependent color variation of a second recording medium.

A color processing apparatus according to the present disclosure includes one or more circuits; or one or more processors and at least one memory, the at least one memory being coupled to the one or more processors and having stored thereon instructions executable by the one or more processors, wherein at least one of the one or more circuits or the execution of the instructions causes the image processing apparatus to function as: an obtaining unit configured to obtain color information of a color chart printed on a first recording medium, a storage unit configured to store, for a plurality of recording media, color information indicating a color after a first predetermined time has passed, the color being printed on the recording media, and correction information for correcting the color indicated by the color information to a color after a second predetermined time longer than the first predetermined time has passed such that the color information and the correction information are related to each other, and a processing unit configured to identify target color information to be used for the first recording medium from the stored color information in accordance with the obtained color information and execute printing processing for printing an image on the first recording medium by using the correction information corresponding to the identified target color information.

Further features of the present disclosure will become apparent from the following description of exemplary embodiments with reference to the attached drawings.

### BRIEF DESCRIPTION OF THE DRAWINGS

FIG. 1 is a schematic diagram illustrating an example of a configuration of an inkjet recording apparatus.

FIG. 2 is a block diagram illustrating a functional configuration of the inkjet recording apparatus.

FIG. 3 is a block diagram of a printer control unit in the inkjet recording apparatus.

FIG. 4 is a flowchart of image processing performed by a recording data generating unit.

FIG. 5 is a block diagram illustrating a configuration of color adjustment performed in color shift correction processing.

FIG. 6 is a flowchart illustrating calibration processing against time-dependent color variation.

FIG. 7 is a block diagram illustrating a configuration of color adjustment performed in the color shift correction processing.

FIG. 8 is a flowchart of borrowing calibration processing.

FIG. 9 is an example of a color chart for recording medium identification.

FIGS. 10A and 10B illustrate time-dependent color variation in recording media.

FIGS. 11A and 11B are examples of recording media used in examples and comparative examples and recording media on a database.

### DESCRIPTION OF THE EMBODIMENTS

Hereinafter, an embodiment is described to explain the present disclosure in detail. The scope of the present disclosure is not limited by the following description. Not all elements to be described according to the present embodiment are required elements of the present disclosure, and the elements may be appropriately combined. Although an inkjet recording apparatus is used as a recording apparatus for the description, a recording apparatus using an electrophotographic method or any of offset methods may be used.

### Inkjet Recording Apparatus

Hereinafter, the inkjet recording apparatus according to the embodiment of the present disclosure is described with reference to the drawings.

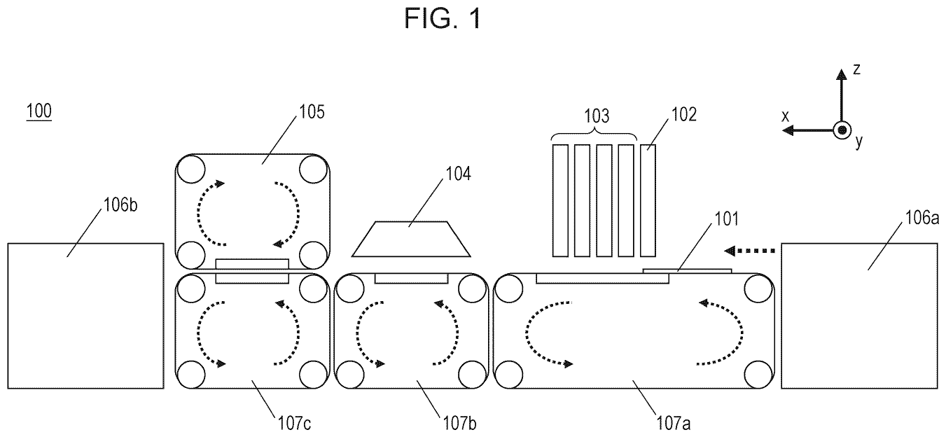

FIG. 1 is a schematic diagram illustrating an example of a general configuration of an inkjet recording apparatus 100. The recording apparatus is a sheet-printing type inkjet recording apparatus configured to produce recorded matter forming an image on a recording medium 101 by using two liquids, that is, a reaction liquid and ink. According to the present embodiment, the X direction, the Y direction, and the Z direction respectively indicate a width direction (full length direction), a depth direction, and a height direction of the inkjet recording apparatus 100. The recording medium 101 is conveyed in the X direction.

The inkjet recording apparatus 100 includes conveying units 107a, 107b, and 107c that convey the recording medium 101 in the X direction. The inkjet recording apparatus 100 also includes a sheet feeding unit 106a configured to feed the recording medium 101 to the conveying unit 107a and a sheet delivery unit 106b configured to collect from the conveying unit 107c the recording medium 101 having undergone printing. The inkjet recording apparatus 100 also includes a reaction liquid applying unit 102 configured to apply to the recording medium 101 the reaction liquid reacting with the ink and an ink applying unit 103 that includes an inkjet head configured to apply, to form the image, the ink to the recording medium 101 to which the reaction liquid has been applied. The inkjet recording apparatus 100 also includes a hot-air drying unit 104 configured to heat the liquid component for drying the image and a fixing unit 105 that fixes the ink.

### Recording Medium and Recording Medium Conveying Device

According to the present embodiment, the recording medium 101 is not particularly limited, and a known recording medium can be used. Examples of the recording medium include a long sheet rolled into a roll shape or a cut sheet cut into a predetermined size.

In the inkjet recording apparatus 100 according to the present embodiment, the recording medium 101 is conveyed in the X direction by the conveying units 107a, 107b, and 107c. Each of the conveying units 107a, 107b, and 107c is a belt rotating about a rotation shaft extending in the Y direction. Examples of the material of the conveying units 107a, 107b, and 107c include resin, metal, and so forth. The belt of each of the conveying units 107a and 107b can have numerous holes so as to allow the recording medium on the belt to be secured by using a suction pump installed under the belt.

Referring to FIG. 1, dotted arrows inside a shape of each element indicate a rotation direction of the element, and a dotted arrow outside the elements indicates a conveyance path of the recording medium 101. The recording medium 101 is conveyed from the sheet feeding unit 106a to the conveying unit 107a. The image is formed on the recording medium 101 on the conveying unit 107a by using the reaction liquid applying unit 102 and the ink applying unit 103. In order to suppress a shift of the recording medium 101 on the conveying unit 107a during formation of the image, a securing device 108 installed under the belt of the conveying unit 107a sucks the recording medium 101 with vacuum applied by the suction pump or the like to secure the recording medium 101 to the belt.

The recording medium 101 on which the image has been formed is conveyed from the conveying unit 107a to the conveying unit 107b. In the conveying unit 107b, regarding the recording medium 101, the hot-air drying unit 104 dries the recording medium 101 while the recording medium 101 is being secured to the belt.

After that, the recording medium 101 is conveyed from the conveying unit 107b to the conveying unit 107c. When the fixing unit 105 heats the recording medium 101, the ink is fixed to the recording medium 101 on the conveying unit 107c.

The recording medium 101 is conveyed from the conveying unit 107c to the sheet delivery unit 106b and stacked in the sheet delivery unit 106b.

### Hot-Air Drying Unit

As illustrated in FIG. 1, when the hot-air drying unit 104 applies hot air to a surface where the reaction liquid and the ink are applied, the surface can be heated and dried. Also, by heating from the back side of the surface where the reaction liquid and the ink are applied, both the sides may be heated and dried.

A hot air temperature and a back surface heating temperature are preferably higher than or equal to 40° C. and lower than or equal to 100° C., and more preferably, higher than or equal to 60° C. and lower than or equal to 80° C. After water included in the reaction liquid and the ink is dried by the hot-air drying, the water content is preferably smaller than or equal to 10 mass % to suppress cockling of the recording medium 101 and greater than or equal to 2 mass % to maintain fastness of an ink film after the fixing.

### Fixing Unit

The fixing unit 105 is configured to heat and solidify the ink applied to the recording medium 101. When the recording medium 101 on which the image has been formed is heated and dried, a coating film is formed from resin particles included in the ink. When the ink is formed into the coating film on the recording medium 101 as described above, a high-definition image having good scratch resistance can be obtained.

### Reaction Liquid Applying Unit

The inkjet recording apparatus 100 according to the present embodiment includes the reaction liquid applying unit 102 configured to apply the reaction liquid to the recording medium 101. When the reaction liquid is brought into contact with the ink, the fluidity of the ink and/or a subset of compositions of the ink on the recording medium 101 is reduced. Thus, bleeding and beading can be suppressed during image formation with the ink. Specifically, when a reactant (also referred to as an ink viscosity increasing component) included in the reaction liquid is brought into contact with a color material, resin, and the like that are the subset of the compositions included in the ink, chemical reaction or physical absorption occurs.

This increases the viscosity of the entirety of the ink and a local viscosity occurring due to aggregation of a subset of components included in the ink such as the color material. Thus, the fluidity of the ink and/or the subset of the compositions of the ink can be reduced. The application of the reaction liquid may be performed before or after the application of the ink as long as the reaction liquid can be mixed with (reacts with) the ink on the recording medium 101.

### Ink Applying Unit

According to the present embodiment, the inkjet head is used as the ink applying unit 103 that applies the ink. Examples of the form of the inkjet head include, for example, a form in which the ink is film boiled by an electrothermal transducer to form air bubbles to discharge the ink, a form in which the ink is discharged by an electromechanical transducer, a form in which the ink is discharged by using static electricity, and the like.

According to the present embodiment, the inkjet head is a line head extending in the Y direction. In the inkjet head, nozzles are arranged in a range covering the width of an image recording region of the recording medium of the maximum usable size. The inkjet head has an ink discharge surface in which the nozzles are opening on a lower surface thereof (on the recording medium 101 side). The ink discharge surface faces the surface of the recording medium 101 with a small gap (about a few to several mm) formed therebetween.

An ink application amount can be represented by a density value of image data, an ink thickness, or the like. According to the present embodiment, the mass of each ink dot is multiplied by the number of applications, and the result is divided by a printing area to obtain an average value. This average value is defined as the ink application amount (g/m²). From the viewpoint of removing the liquid component in the ink, the maximum ink application amount in an image region indicates the ink application amount applied to an area of at least 5 mm² in a region used as information of a discharge object medium.

The ink applying unit 103 may include a plurality of inkjet heads to apply inks of different colors to the recording medium 101. For example, when color images are formed by using a yellow ink, a magenta ink, a cyan ink, and a black ink, respectively, the ink applying unit 103 includes four inkjet heads that discharge the four types of inks, respectively, onto the recording medium 101. These inkjet heads are arranged in the X direction.

### Ink

Hereinafter, the components and the like of the ink used according to the present embodiment are described in detail. Although an aqueous pigment ink is used as an example according to the present embodiment, the present disclosure is not limited to the aqueous pigment ink.

### Color Material

The ink can contain a color material. Examples of the color material to be used can include a pigment and a dye. The content (mass %) of the color material in the ink is, with reference to the entire mass of the ink, preferably greater than or equal to 0.5 mass % and smaller than or equal to 15.0 mass %, and more preferably greater than or equal to 1.0 mass % and smaller than or equal to 10.0 mass %.

Specific examples of the pigment can include inorganic pigments such as carbon black and titanium oxide and organic pigments such as azo, phthalocyanine, quinacridone, isoindolinone, imidazolone, diketo-pyrrolo-pyrrole, and dioxazine.

As a method for dispersing the pigment, a resin dispersion pigment using resin as a dispersant, a self-dispersing pigment in which a hydrophilic group is bonded to the surface of the particle of the pigment, or the like can be used. Furthermore, a resin-bonded pigment in which an organic group including resin is chemically bonded to the surface of the particle of the pigment, a microcapsule pigment in which the surface of the particle of the pigment is coated with, for example, resin, or the like can be used.

As a resin dispersant for dispersing the pigment in an aqueous medium, a dispersant that can disperse the pigment in the aqueous medium by the action of an anionic group can be used. As the resin dispersant, water-soluble resin can be used out of resins, which will be described later. The content (mass %) of the pigment in the ink is, in mass ratio of the resin dispersant to the content, preferably greater than or equal to 0.3 times and smaller than or equal to 10.0 times.

As the self-dispersing pigment, a pigment as follows can be used: a pigment in which the anionic group such as a carboxylic acid group, a sulfonic acid group, or a phosphonic acid group is bonded directly to the surface of the particle of the pigment or bonded to the surface of the particle of the pigment with another atomic group (—R—) interposed therebetween. The anionic group may be either an acid type or a salt type. When the anionic group is of the salt type, the anionic group may be either in a state in which part of the anionic group is dissociated or in a state in which the entirety of the anionic group is dissociated. When the anionic group is of the salt type, examples of a cation becoming a counter ion can include alkali metal cation, ammonium, organic ammonium, and the like. Specific examples of the other atomic group (—R—) can include a straight-chain or branched alkylene group of 1 to 12 carbon atoms, an arylene group such as a phenylene group or a naphthylene group, a carbonyl group, an imino group, an amido group, a sulphonyl group, an ester group, an ether group, and the like. The other atomic group may be a group obtained by combining these groups.

As the dye, a dye having an anionic group can be used. Specific examples of the dye can include dyes such as azo, triphenylmethane, (aza) phthalocyanine, xanthene, and anthrapyridone. The color material can be a pigment, and the color material is desirably a resin dispersant pigment.

### Resin

The ink can contain the resin particles. When the ink containing the resin particles is used, image peeling can be suppressed, and an image having an improved fixing property and an improved scratch resistance can be recorded. The ink may further contain water-soluble resin that can dissolve in an aqueous medium. The water-soluble resin can be added to the ink so as to stabilize the dispersion state of the pigment, that is, as the resin dispersant or an auxiliary agent of the resin dispersant (i) and so as to improve various characteristics of the image to be recorded (ii).

The content (mass %) of the resin in the ink is, with reference to the entire mass of the ink, preferably greater than or equal to 0.1 mass % and smaller than or equal to 20.0 mass %, and more preferably greater than or equal to 0.5 mass % and smaller than or equal to 15.0 mass %. Examples of the form of the resin can include, for example, a block copolymer, a random copolymer, a graft copolymer, and a combination of these.

### Composition of Resin

Examples of the resin can include, for example, an acrylic resin, a urethane resin, and an olefinic resin.

### Wax Particle

The ink can contain a particle formed of wax (wax particle). When the wax is contained in the ink, a slipping property of the surface of a printed product can be improved, and accordingly, effects such as reduction of abrasion of printed portions and prevention of mutual blocking of printed products can be obtained.

### Aqueous Medium

The ink used in a method for recording according to the present embodiment is an aqueous ink containing at least water as an aqueous medium. The ink can contain the water or an aqueous medium that is a mixed solvent of the water and a water-soluble organic solvent.

As the water-soluble organic solvent contained in the ink, a water-soluble organic solvent with a boiling point of equal to or higher than 250° C. can be used since use of this solvent can contribute to suppressing of solidification in the inkjet head caused by drying of the water. For example, glycerin or the like can be used. Furthermore, from the viewpoint of suppressing deformation of a sheet of the printed product, the following specific water-soluble hydrocarbon compound can be contained. This water-soluble hydrocarbon compound is compound having a hydrocarbon chain of carbon number of three or more substituted by two or more hydrophilic groups selected from the group consisting of a hydroxy group, an amino group, and an anionic group. However, the hydrocarbon chain can be terminated by a sulphonyl group or an ester group.

The content (mass %) of the water-soluble hydrocarbon compound in the ink is, with reference to the entire mass of the ink, preferably greater than or equal to 1.0 mass % and smaller than or equal to 20.0 mass %.

### Other Component

The ink may contain various other components according to need. Examples of the other components can include various additives such as an antifoaming agent, a surface-active agent, a pH adjuster, a viscosity modifier, an anticorrosive, an antiseptic, an antifungal agent, an anti-oxidant, and a reduction inhibitor.

### Physical Properties of Ink

The ink according to the present embodiment is an aqueous ink applied to an inkjet method. Accordingly, from the viewpoint of reliability, physical properties of the ink can be appropriately controlled. Specifically, the surface tension of the ink at 25° C. is preferably greater than or equal to 20 mN/m and smaller than or equal to 60 mN/m. The viscosity of the ink at 25° C. is preferably greater than or equal to 1.0 mPa·s and smaller than or equal to 10.0 mPa·s. Preferably, pH of the ink at 25° C. is greater than or equal to 7.0 and smaller than or equal to 9.5, and more preferably greater than or equal to 8.0 and smaller than or equal to 9.5.

### Control System

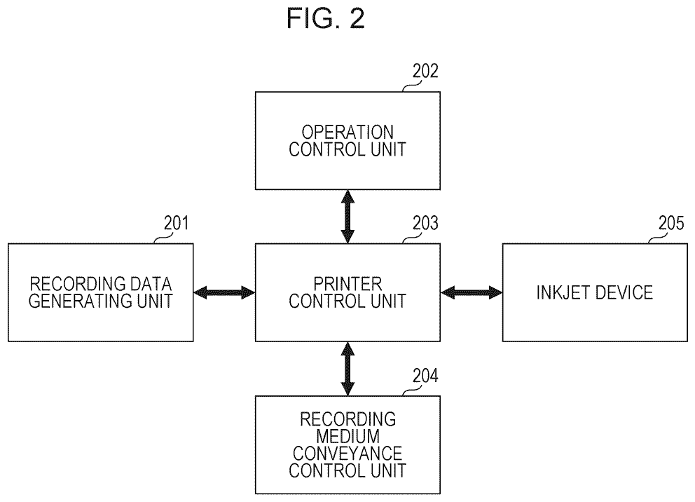

The inkjet recording apparatus according to the present embodiment has a control system that controls various devices. FIG. 2 is a block diagram illustrating the control system of the entirety of the inkjet recording apparatus illustrated in FIG. 1. The control system includes a recording data generating unit 201 such as an external print server, an operation control unit 202 such as an operation panel, a printer control unit 203 for executing a recording process, and a recording medium conveyance control unit 204 for conveying the recording medium. The control system also includes an inkjet device 205 for printing.

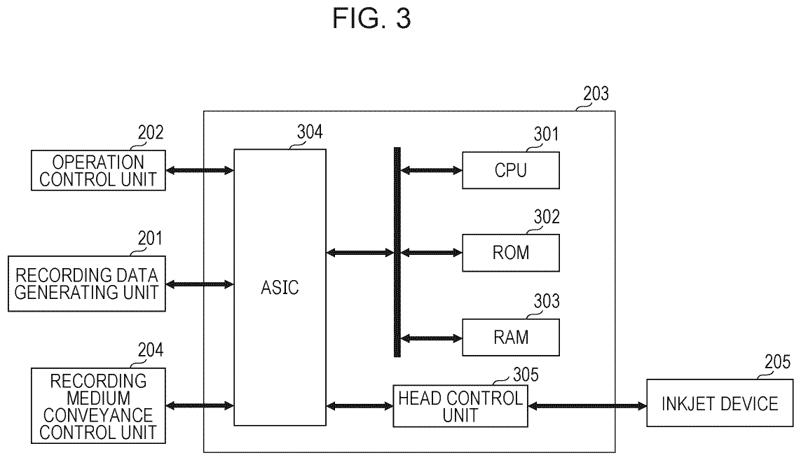

FIG. 3 is a block diagram of the printer control unit 203 in the inkjet recording apparatus illustrated in FIG. 1. The printer control unit 203 includes a central processing unit (CPU) 301 configured to control the entirety of the printer, a read only memory (ROM) 302 configured to store a control program of the CPU, and a random access memory (RAM) 303 for executing the program. An application specific integrated circuit (ASIC) 304 includes the following components therein. That is, a network controller, a serial interface (IF) controller, a head data generating controller, a motor controller, and the like. A head control unit 305 is configured to generate final discharge data of the inkjet device 205, a drive voltage, and the like.

### Generation of Recording Data

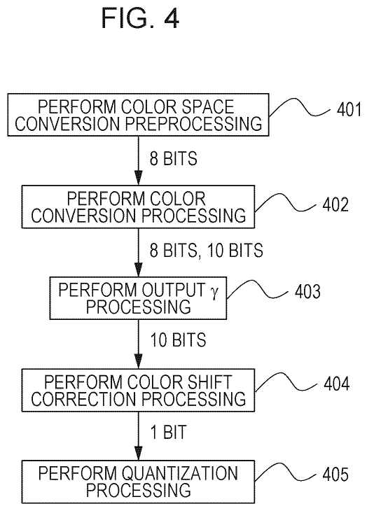

FIG. 4 is a flowchart of image processing performed by the recording data generating unit 201 for generating recording data in the recording system according to the present embodiment having been described with reference to FIGS. 1 to 3. In the image processing according to the present embodiment, pieces of image data (pieces of luminance data) of colors red (R), green (G), and blue (B) are input. The pieces of image data of the colors each includes eight bits (256 levels of gray). At last, a process is performed which outputs bit image data (recording data) of a single bit discharged by recording heads of cyan (C), magenta (M), yellow (Y), and black (K). The types of colors or the gradation of colors is not limited to the above-described values.

In S401, by using a three-dimensional color conversion table, the pieces of image data of the colors R, G, and B each represented by an eight-bit luminance signal are converted into pieces of data of R′, G′, and B′ each represented by eight bits or ten bits. This color space conversion preprocessing (also referred to as precedent color processing) is performed to correct the difference between a color space represented by the pieces of image data of R, G, and B in a recording object and a color space reproducible by the recording apparatus.

In S402, regarding the pieces of data of the colors R′, G′, and B′ having undergone the precedent color processing, the three-dimensional color conversion table is used to convert these pieces of data of the colors R′, G′, and B′ having undergone the precedent color processing into pieces of data of C, M, Y, and K colors. Each of the pieces of data of C, M, Y, and K colors is ten-bit data. This color conversion processing (also referred to as post processing) converts in color the pieces of RGB-system image data of an input system represented by the luminance signals into the pieces of image data of C, M, Y, and K to be used in the inkjet device 205.

In S403, an output y correction is performed on the piece of ten-bit data of each of the C, M, Y, and K colors having undergone the post processing by using a one-dimensional color conversion table for the color. Normally, the number of dots recorded per unit area of a recording medium and recording characteristics such as reflection density obtained by measuring a recorded image are not linearly related. Accordingly, to establish linear relationships between input tone levels of each of the pieces of ten-bit data of C, M, Y, and K and the density level of an image recorded by the pieces of ten-bit data, output y correction processing is performed to correct the input tone level of each of the pieces of the ten-bit data of C, M, Y, and K.

In S404, according to the present embodiment, the output y correction of color shift correction processing is performed on the piece of ten-bit data of each of the C, M, Y, and K colors having undergone the output y correction by using a one-dimensional color conversion table for color shift correction for the color. For example, there are individual differences between discharge amounts from individual nozzles in the recording head configured to discharge the ink used in the recording apparatus, that is the dot sizes to be recorded. Accordingly, even when the number of dots to be recorded is adjusted by the output y correction using the above-described one-dimensional color conversion table, a color shift may occur due to the difference in obtained optical density. For this reason, according to the present embodiment, the color shift correction processing is performed by using the one-dimensional color conversion table for color shift correction for each of the C, M, Y, and K colors. The one-dimensional color conversion table for color shift correction is an image processing parameter to be created or updated by calibration against the time-dependent color variation, which will be described later in various embodiments.

In S405, the pieces of ten-bit data of the C, M, Y, and K colors are converted into pieces of a single-bit binary data of the C, M, Y, and K colors by binarization processing (quantization processing).

### Recording Medium

The recording medium is not particularly limited. Any of non-coated paper such as high-quality paper or ordinary paper, offset coated paper having a coating layer including calcium carbonate or kaoline, a polyethylene terephthalate (PET) film, inkjet dedicated paper having a liquid reception layer for inkjet, and the like can be used. Among these, a recording medium with a low absorbency for aqueous ink (low-absorbent recording medium) can be used for the present disclosure.

The low-absorbent recording medium is a recording medium with a water absorbing amount greater than or equal to 4 mL/m² and smaller than or equal to 10 mL/m² from the start of contact to 30 msec^{1/2} in a Bristow method. Examples of the low-absorbent recording medium include, for example, a recording medium without an ink reception layer and a recording medium with a thin ink reception layer. Examples of such a recording medium include, for example, actual printing paper such as art paper, high-quality coated paper, medium-quality coated paper, high-quality lightweight coated paper, medium-quality lightweight coated paper, fine coated paper, and cast-coated paper.

### Calibration Against Time-Dependent Color Variation

### Printing and Colorimetry of Color Chart

Next, calibration against time-dependent color variation according to the present embodiment is described. Calibration is executed when a calibration start instruction is input by a user using the operation control unit 202 or as part of processing by the CPU 301 in the printer control unit illustrated in FIG. 3.

This calibration first records a color chart for creation of a color conversion table for a recording medium for which a new color conversion table for time-dependent color variation is wanted to be created. Although the color chart for creation of a color conversion table can be appropriately set depending on a target correction accuracy and the number of colors used, reproduction accuracy of a target color increases as the number of colors in the chart increases.

Colorimetry of the color chart recorded in the above-described recording medium is performed during a predetermined first time. The first time indicates a time period elapsed after printing has been performed on the recording medium. Setting of the first time is not limited, and the first time is a few to several seconds immediately after drying and fixing or a few to several days after the drying and fixing. However, from the viewpoint of making use of the aforementioned effect of the disclosure, the first time can be set at a time within one minute after the drying and fixing. In this way, a standby time before the calibration can be reduced. The colorimetry may be carried out inside or outside the recording apparatus.

Color space information obtained by the colorimetry may be a signal value of any of various color specification systems. For example, a CIE color specification system, an RGB color specification system, or an XYZ color specification system can be appropriately used. According to the present embodiment, L*, a*, and b* color space signal values (hereinafter, described as L*a*b* values) of the CIE color specification system that is currently highly versatile are used. For the colorimetry, any of various types of commercially available colorimeters can be used.

Calculation of Color Space Signal Value after Elapse of Time

The L*a*b* values of colors after the colors of an unregistered recording medium have been stabilized are predicted and calculated from L*a*b* values in the first time and a time-dependent color variation amount of a recording medium of the same system serving as the reference. Hereinafter, a time taken from printing to stabilization of colors is defined as a second time, and the second time is described by using examples of specific value variation with Tables 1-1 to 1-3. Regarding Table 1-1, the color chart for creation of a color conversion table is created with a reference recording medium, and the L*a*b* values in the first time, the L*a*b* values in the second time, and differences of these (ΔL*, Δa*, and Δb*) are listed in Table 1-1. Since the second time required for the time-dependent color variation varies depending on the recording medium and the type of color material such as the ink, the second time is required to be calculated on an apparatus-by-apparatus basis. For example, in the calculation of the second time according to the present embodiment, the second time is set as follows: when a color difference ΔE of the color space signal values measured every four hours falls within 0.05 three consecutive times, a time until the last value of the three values is measured is set as the second time.

TABLE 1-1
Reference recording medium

| | First Time | | | Second time | | | Time-dependent variation value | | |
|---|---|---|---|---|---|---|---|---|---|
| | L* | a* | b* | L* | a* | b* | ΔL* | Δa* | Δb* |
| 1 | 46.675 | −32.36 | −57.34 | 47.5 | −33.09 | −57.555 | 0.825 | −0.73 | −0.215 |
| 2 | 49.96 | −34.495 | −55.155 | 50.715 | −35.175 | −55.265 | 0.755 | −0.68 | −0.11 |
| 3 | 88.535 | −7.39 | 105.27 | 89.09 | −7.585 | 105.82 | 0.555 | −0.195 | 0.55 |
| 4 | 31.385 | 59.68 | −30.175 | 32.48 | 60.745 | −29.04 | 1.095 | 1.065 | 1.135 |
| 5 | 28.98 | 33.35 | 0.655 | 30.48 | 34.75 | 1.21 | 1.5 | 1.4 | 0.555 |
| . | . | . | . | . | . | . | . | . | . |
| . | . | . | . | . | . | . | . | . | . |
| 924 | 11.13 | −1.98 | 4.385 | 11.475 | −2.115 | 4.565 | 0.345 | −0.135 | 0.18 |
| 925 | 10.33 | 2.24 | 6.62 | 10.865 | 2.265 | 7.165 | 0.535 | 0.025 | 0.545 |
| 926 | 5.605 | 7.51 | 0.36 | 5.78 | 7.95 | 0.29 | 0.175 | 0.44 | −0.07 |
| 927 | 5.43 | −1.67 | −0.805 | 5.585 | −1.795 | −0.965 | 0.155 | −0.125 | −0.16 |
| 928 | 93.73 | 0.755 | −3.235 | 93.99 | 0.805 | −3.5 | 0.26 | 0.05 | −0.265 |

For the color difference ΔE, an ordinary color difference formula can be appropriately used. Examples of such a color difference formula include, for example, a CIE 1976 color difference formula (ΔE76), a CIE 1994 formula (ΔE94), and a CIE 2000 formula (ΔE00). According to the present embodiment, ΔE00 (hereinafter, represented as ΔE) that can be used in view of perceptual uniformity is used.

Variation Amount of Color Space Signal Value and Prediction of Unregistered Recording Medium after Elapse of Time

Table 1-2 indicates a subset of L*, a*, and b* of the colors when the color chart for creation of a color conversion table is subjected to colorimetry in the first time. This color chart is recorded on a recording medium without color conversion table registration (hereinafter, referred to as an unregistered recording medium). Herein, commercially available ordinary coated paper is used as the unregistered recording medium.

Color variation information of the reference recording medium calculated in advance in Table 1-1 is applied to these color space signal values in the first time to predict and calculate L*a*b* values in the second time on the unregistered recording medium as predicted color information. Predicted L*a*b* values in the second time are calculated by simply adding ΔL*, Δa*, and Δb* values calculated in advance with the reference recording medium to the L*a*b* values of the colors of the unregistered recording medium in the first time. The method for predicting the L*a*b* values in the second time is not limited to simple addition and can be appropriately changed depending on the characteristics of the recording apparatus to be used or the characteristics of the ink.

An important point is that the category of the unregistered recording medium agrees with the category of the reference recording medium. Roughly categorized, recording media is categorized into two types, that is, an absorbent recording medium such as non-coated paper and inkjet coated paper processed to have a porous surface and a low-absorbent recording medium such as offset coated paper. When the category of the unregistered recording medium can be identified, more detailed categorization is possible. In this case, for example, categorization or the like exemplified in the above described “Recording Medium” can be used.

TABLE 1-2
Unregistered recording medium

| | First Time | | | Second time (predicted value) | | | Time-dependent variation value | | |
|---|---|---|---|---|---|---|---|---|---|
| | L* | a* | b* | L* | a* | b* | ΔL* | Δa* | Δb* |
| 1 | 48.12 | −31.045 | −57.715 | 48.945 | −31.775 | −57.93 | 0.825 | −0.73 | −0.215 |
| 2 | 51.705 | −31.94 | −55.235 | 52.46 | −32.62 | −55.345 | 0.755 | −0.68 | −0.11 |
| 3 | 89.225 | −8.48 | 101.245 | 89.78 | −8.675 | 101.795 | 0.555 | −0.195 | 0.55 |
| 4 | 32.055 | 56.465 | −32.575 | 33.15 | 57.53 | −31.44 | 1.095 | 1.065 | 1.135 |
| 5 | 29.88 | 28.92 | −2.655 | 31.38 | 30.32 | −2.1 | 1.5 | 1.4 | 0.555 |
| . | . | . | . | . | . | . | . | . | . |
| . | . | . | . | . | . | . | . | . | . |
| 924 | 15.715 | −2.085 | 3.935 | 16.06 | −2.22 | 4.115 | 0.345 | −0.135 | 0.18 |
| 925 | 13.46 | 2.205 | 6.05 | 13.995 | 2.23 | 6.595 | 0.535 | 0.025 | 0.545 |
| 926 | 8.5 | 9 | 0.765 | 8.675 | 9.44 | 0.695 | 0.175 | 0.44 | −0.07 |
| 927 | 8.265 | −2.31 | −0.59 | 8.42 | −2.435 | −0.75 | 0.155 | −0.125 | −0.16 |
| 928 | 94.665 | 1.44 | −7.91 | 94.925 | 1.49 | −8.175 | 0.26 | 0.05 | −0.265 |

Creation of Color Conversion Table in which Time-Dependent Color Variation is

### Considered and Image Processing

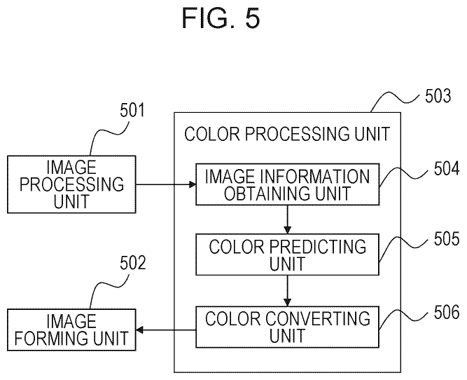

The details of color adjustment are described with reference to FIG. 5. The color adjustment is performed in an image processing unit 501 in the recording data generating unit 201. The image processing unit 501 is configured to perform the color adjustment on YMCK data so that the YMCK data matches target colors to be output by an image forming unit 502 corresponding to the YMCK data. This conversion according to the present embodiment is performed by using the color conversion table used to convert the L*a*b* color space information obtained by colorimetry into Y′M′C′K′ data to be output.

The color conversion table is used to correct a color mixture by updating a three-dimensional color conversion table used to convert a device independent color space (L*a*b*) into a device dependent color space (CMYK).

The color conversion table is created by a color processing unit 503. The color processing unit 503 is configured to calculate the color information in the second time by obtaining the color information on the above-described chart for creation of a color conversion table at an image information obtaining unit 504 and adding a time-dependent color variation amount of each color to the color information in the first time at a color predicting unit 505.

When this color information is calculated, a color conversion table in which the time-dependent color variation characteristics are considered can be created. A color converting unit 506 is configured to create the color conversion table based on the color information in the second time. Specifically, after the colors have varied with time, the color space signal values of the target (L*₍ₜ₎, a*₍ₜ₎, and b*₍ₜ₎) are converted into input values Y′, M′, C′, and K′ of the colors.

### Flow of Calibration Against Time-Dependent Color Variation

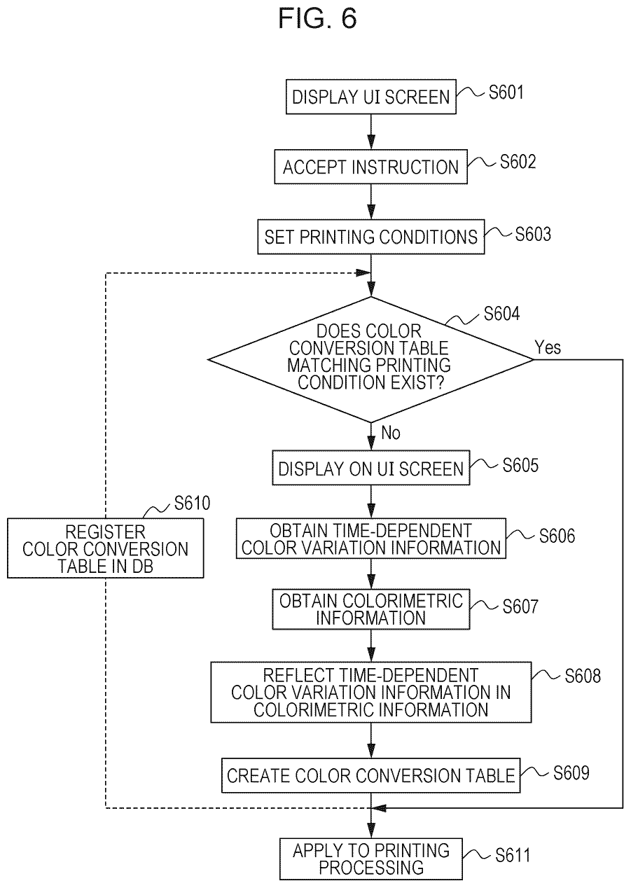

FIG. 6 is a flowchart illustrating a procedure of calibration processing.

In S601, when printing is performed, a user interface (UI) screen for setting the printing conditions is displayed on a display. In the UI screen, a list of names of recording media stored in the printing apparatus is displayed to specify a recording medium that is one of the printing conditions.

In S602, a selection instruction by the user is accepted in the displayed recording medium list. A list of categories of the recording media may be displayed first to accept the selection instruction by the user. In this case, after acceptance of the category list, a list of recording media categorized into the selected category is displayed so as to accept the selection instruction by the user in the recording medium list. Listed items are not necessarily the names of recording media. For example, serial numbers may be listed. It is sufficient that the listed items be identifiers with which recording media can be identified.

In S603, a recording medium identified by the accepted selection instruction by the user is set as the printing condition. The printing conditions include not only the recording medium but also quality of printing and the like.

In S604, it is checked that whether the color conversion table for the recording medium having been set above exists on a database (DB) of the recording apparatus. Specifically, names of recording media and color conversion tables corresponding to these names are stored on the DB with the recording medium names and the color conversion tables associated with each other. Accordingly, when a stored name and the name having been set above are compared, whether the color conversion table is stored is checked.

As a result of the check, when the color conversion table exists on the DB, in S608, calibration against the time-dependent color variation can be executed by applying the existing color conversion table to the recording apparatus.

In contrast, as a result of the check, when the color conversion table does not exist on the DB, the following processing is performed in S605. That is, the following items are displayed on the UI screen: a message indicating that the set color conversion table does not exist on the DB; and the category (e.g., coated paper or non-coated paper) of an unregistered recording medium (second recording medium) on which printing is to be performed.

In S606, a selection instruction by the user for the displayed category is accepted. When the category is identified, the above-described color variation information having been stored in advance for the reference recording medium (first recording medium) is also identified. The reference recording medium is a representative recording medium determined in advance on a category-by-category basis.

Although the selection instruction is an instruction manually input by the user via the operation control unit, this is not limiting. For example, an instruction to read a recording medium on which printing is to be performed is set to be acceptable from the UI screen, and the characteristics of the recording medium are read by this instruction. Meanwhile, the characteristics of each of representative recording media for the above-described categories or each of the stored recording media may also be set to be stored on the above-described DB. These stored characteristics and the obtained characteristics may be compared to identify a recording medium with the highest matching level. Also in this case, when the reference recording medium is identified, the color variation information associated with the recording medium is also identified.

In S607, an instruction is transmitted to the image forming unit. This instruction is for printing the color chart for creation of a color conversion table on the recording medium on which the printing is to be performed. The color chart having been printed in the image forming unit is obtained, with a scanner, as colorimetric information measured in the first time. The colorimetric information of the printed image in this case is obtained in L*a*b* values.

In S608, the color variation information of the reference recording medium identified in S606 is added to the obtained colorimetric information, and the predicted color information after the elapse of the second time is generated. The second time is longer than the above-described first time and allows color development to be stabilized due to a passage of time. The predicted color information is generated by using the above-described method.

In S609, based on the generated predicted color information, the colorimetric information measured in the first time is corrected for the unregistered recording medium on which printing is to be performed, thereby to create a second color conversion table for the unregistered recording medium. That is, with this correction, the color variation characteristics of the unregistered medium is obtained. As specific processing of the correction, the L*a*b* values that are the colorimetric information included in a first color conversion table may be replaced with the predicted color information or the predicted color information may be added to the first color conversion table.

In S610, the newly created second color conversion table is stored in memory in a storage medium. The newly created second color conversion table may be registered in the above-described DB in S603 with the second color conversion table related to the second recording medium.

In S611, the created color conversion table is applied to printing processing of the image data.

Table 1-3 specifically indicates the effect of predictive correction. Table 1-3 lists color space signal values in the case where predictive color correction is applied to the unregistered recording medium and color space signal values in the case of no correction with Table 1-1 and Table 1-2 set as examples of the reference recording medium and the unregistered recording medium. The details of the printing conditions and the like are the same as those of examples to be described later. As an evaluation chart, a 100-patch color chart is used. This chart is in conformity with ISO 12647 standard (Process control for the production of half-tone colour separations, proof and production prints). When examining ΔE values, which compare corrected and uncorrected color space signal values with target values for patches of applying amount ratios of each of C, M, Y, and K. For example, as in patch 99, ΔE is 1.82 in the uncorrected case while ΔE is 0.75 in the corrected case. The color difference can be corrected to the degree of a color difference at which the difference is hardly perceived when colors spaced a little apart from each other are compared.

TABLE 1-3

| | Applying amount | | | | | | | Uncorrected color space | | | | Corrected color space | | | |
|---|---|---|---|---|---|---|---|---|---|---|---|---|---|---|---|
| Patch | ratio | | | | Target color | | | signal value | | | | signal value | | | |
| No. | C | M | Y | K | L* | a* | b* | L* | a* | b* | ΔΕ | L* | a* | b* | ΔΕ |
| 1 | 255 | 0 | 0 | 0 | 48.38 | −31.55 | −57.56 | 47.86 | −31.25 | −57.69 | 0.563175 | 48.42 | −31.15 | −58 | 0.224382 |
| 2 | 0 | 0 | 10 | 0 | 93.87 | −1.86 | 6.57 | 93.83 | −1.99 | 7.19 | 0.448261 | 93.91 | −1.92 | 6.61 | 0.08493 |
| 3 | 0 | 181 | 181 | 0 | 48.31 | 69.43 | 56.88 | 48 | 70 | 57.3 | 0.513546 | 48.44 | 68.94 | 56.83 | 0.206387 |
| 4 | 137 | 93 | 93 | 0 | 28.45 | −10.11 | −3.42 | 27.63 | −10.27 | −2.94 | 1.372917 | 28.74 | −9.25 | −3.5 | 0.825085 |
| . | . | . | . | . | . | . | . | . | . | . | . | . | . | . | . |
| . | . | . | . | . | . | . | . | . | . | . | . | . | . | . | . |
| 97 | 162 | 29 | 29 | 34 | 33.78 | −27.04 | −23.4 | 32.9 | −26.49 | −21.91 | 1.469578 | 34.25 | −26.45 | −23.87 | 0.571629 |
| 98 | 152 | 152 | 34 | 0 | 21.21 | 15.69 | −37.68 | 20.67 | 15.65 | −37.22 | 0.604685 | 21.41 | 16.1 | −38.09 | 0.220157 |
| 99 | 10 | 64 | 142 | 0 | 60.34 | −44.05 | 49.41 | 59.33 | −45.27 | 48.54 | 1.820499 | 60.81 | −43.03 | 50.41 | 0.748432 |
| 100 | 29 | 20 | 20 | 0 | 72.64 | −3.45 | −7.67 | 72.24 | −3.32 | −7.71 | 0.462012 | 72.75 | −3.22 | −8 | 0.396888 |

### EXAMPLES

Hereinafter, the present disclosure is described in further detail with examples and comparative examples. However, the present disclosure is not limited by the following examples in any way without departing from the gist thereof. When “part” or “%” is described with respect to the amount of a component, these are with reference to mass unless otherwise specified. Recording medium groups described herein are examples and do not limit the range of application.

### Common Conditions

In the present examples, the inkjet recording apparatus 100 illustrated in FIG. 1 was used. The conveyance speed was set to 0.5 m/s, and various recording media to be described later were used as recording media 101. The reaction liquid applied by the reaction liquid applying unit 102 was prepared as follows, and the application amount was set to 2 g/m².

### Preparation of Reaction Liquid

Components described below were mixed, sufficiently agitated, and after that, subjected to pressure filtration with a cellulose acetate filter having a pore size of 3.0 μm to prepare the reaction liquid.
magnesium nitrate 6 hydrate 15.0 mass %
ethylene glycol 8.0 mass %
Acetylenol E100 (registered trademark) 1.0 mass %
ion-exchange water 76.0 mass %

As the ink applying unit 103, an inkjet head of a type in which an electrothermal transducer is used and with which the ink is discharged in an on-demand method was used. The ink application amount was set to 18 g/m².

The ink used was an ink prepared as follows.

### Preparation of Pigment Dispersion Liquid

### Pigment Dispersion Liquid 1

A styrene-ethyl acrylate-acrylic acid copolymer (resin 1) of an acid value of 150 mg KOH/g and a weight average molecular weight of 8,000 was prepared. After 20.0 parts of resin 1 had been neutralized with potassium hydroxide equimolar to the acid value of resin 1, an appropriate amount of pure water was added. Thus, an aqueous solution of resin 1 with a resin content (solid content) of 20.0% was prepared. A mixture was obtained by mixing 10.0 parts of a pigment (C.I. pigment blue 15:3), 15.0 parts of the aqueous solution of resin 1, and 75.0 parts of pure water. The obtained mixture and 200 parts of zirconia beads having a diameter of 0.3 mm were charged into a batch-type vertical sand mill and dispersed for five hours while being cooled by water. After coarse particles had been removed by centrifugation, pressure filtering was performed with a cellulose acetate filter having a pore size of 3.0 μm. Thus, pigment dispersion liquid 1 having a pigment content of 10.0% and a resin dispersant (resin 1) content of 3.0% was prepared.

### Pigment Dispersion Liquid 2

Pigment dispersion liquid 2 having a pigment content of 10.0% and a resin dispersant content (resin 1) of 3.0% was prepared in a procedure similar to that for pigment dispersion liquid 1 described above other than that the pigment was changed to C.I. pigment red 122.

### Pigment Dispersion Liquid 3

Pigment dispersion liquid 3 having a pigment content of 10.0% and a resin dispersant content (resin 1) of 3.0% was prepared in a procedure similar to that for pigment dispersion liquid 1 described above other than that the pigment was changed to C.I. pigment yellow 74.

### Pigment Dispersion Liquid 4

Pigment dispersion liquid 4 having a pigment content of 10.0% and a resin dispersant content (resin 1) of 3.0% was prepared in a procedure similar to that for pigment dispersion liquid 1 described above other than that the pigment was changed to carbon black.

### Preparation of Resin Particle

### Resin Particle Dispersant 1

74.0 parts of ion-exchange water and 0.2 parts of potassium persulfate were charged into a four-neck flask provided with an agitator, a reflux condenser, and a nitrogen gas introductory tube and mixed. Also, 24.0 parts of ethyl methacrylate, 1.5 parts of methacrylic acid, and 0.3 parts of a reactive surface-active agent were mixed to prepare an emulsion. Under a nitrogen atmosphere, the prepared emulsion was caused to drip into the above-described four-neck flask for one hour, and polymerization reaction was performed for two hours while agitating at 80° C. After cooled to 25° C., an aqueous solution including the ion-exchange water and potassium hydroxide equimolar to the acid value of a resin particle was added. Thus, water dispersion liquid 1 of the resin particle having a resin particle content (solid content) of 25.0% was prepared.

### Printing Conditions

A hot-air dryer was used as the hot-air drying unit 104 configured to heat the ink for drying and set so that the surface temperature of the recording medium 101 became a predetermined temperature. The surface temperature of the recording medium was measured by using a radiation thermometer.

A fixing belt that can be heated with a halogen heater from thereinside was used as the fixing unit 105. A polytetrafluoroethylene (PTFE) material was used as a fixing member to be brought into contact with the recording medium. Fixing was performed at a temperature of 90° C. and a fixing pressure of 200 Pa. Regarding the temperature of the fixing member, the surface temperature of the fixing member was measured by using the radiation thermometer.

Under the above-described printing conditions, the color chart for creation of a color conversion table was printed on various types of A3 recording media 101.

### Creation of Color Conversion Table

The printed color chart was subjected to colorimetry after the first time had elapsed to obtain the color space signal values L*a*b*. The colorimetry was performed under the following conditions by using a fluorescent spectrodensitometer.

### Colorimetric Conditions

Measurement environments: 25° C., 50%
Measurement method: Reflection measurement
Illumination conditions: M1 (D50)
Observation field of view: 2°
Observation light source: D50
Polarizing filter: Not mounted

Color space signal values (L*+ΔL*, a*+Δa*, and b*+Δb*) were predicted and calculated by adding, to the L*a*b* values in the first time of the colors of the color chart, ΔL*Δa*Δb* variation amounts of the reference recording medium from the first time to the second time having been checked in advance. A color conversion table for the conversion to CMYK to be output by the device was created from the calculated color space signal values and the color variation values up to the stabilization of the colors.

### Printing of Evaluation Chart

In the present examples, the above-described color conversion table was applied to an image file to print the evaluation chart. As the evaluation chart, a 100-patch color chart was used. This chart is in conformity with ISO 12647 standard (Process control for the production of half-tone colour separations, proof and production prints). Printing was performed under the same printing conditions as the above-described Printing Conditions.

### Example 1

### Preparation of Ink Set a

Components (unit: %) described below were mixed to prepared the cyan, magenta, yellow, and black inks. Resin particle dispersant 1 and pigment dispersants 1 to 4 obtained above were mixed with each of the following components. The cyan ink was prepared only with pigment dispersant 1, the magenta ink was prepared only with pigment dispersant 2, the yellow ink was prepared only with pigment dispersant 3, and the black ink was prepared only with pigment dispersant 4. Thus, the cyan ink, the magenta ink, the yellow ink, and the black ink were created. The remainder for the ion-exchange water refers to an amount with which the sum of all the components included in the ink becomes 100.0 mass %.
pigment dispersant 20.0 mass %
resin particle dispersant 1 24.0 mass %
ethylene glycol 7.0 mass %
surface-active agent 0.5 mass %
ion-exchange water remainder

These were sufficiently agitated, dispersed, and after that, subjected to pressure filtering with a microfilter having a pore size of 3.0 μm to prepare the inks.

When ink set a is heated and fixed after the printing with the recording apparatus according to the present disclosure, water and a water-soluble organic solvent in an ink layer can be substantially completely volatilized. Although ink set a can be used for printing on a sheet of a paper substrate, a non-absorbent film, and the like, printing on the sheet of a paper substrate with ink set a tends to be less effective in suppressing curling or cockling than with ink set b, which will be described later.

In example 1, product 1 of non-coated paper was used as the unregistered recording medium, and product 7 of non-coated paper was used as the reference recording medium. The first time was set to a time ten minutes after the printing. The second time was set to a time 144 hours after the printing so as to allow the colorimetry to be performed after the colors had been sufficiently stabilized.

### Example 2

In example 2, the printing and evaluation were performed under the same conditions as those of example 1 other than that product 2 of non-coated paper was used as the unregistered recording medium.

### Example 3

In example 3, the printing and evaluation were performed under the same conditions as those of example 1 other than that product 3 of coated paper was used as the unregistered recording medium, and product 8 of coated paper was used as the reference recording medium.

### Example 4

In example 4, the printing and evaluation were performed under the same conditions as those of example 3 other than that product 4 of coated paper was used as the unregistered recording medium.

### Example 5

In example 5, the printing and evaluation were performed under the same conditions as those of example 1 other than that product 5 of label paper was used as the unregistered recording medium, and product 9 was used as the reference recording medium.

### Example 6

In example 6, the printing and evaluation were performed under the same conditions as those of example 1 other than that the inks prepared as follows (ink set b) were used.

### Preparation of Ink Set b

The components (unit: %) described below were mixed to prepared the cyan, magenta, yellow, and black inks.

Resin particle dispersant 1 and pigment dispersants 1 to 4 described above were mixed with each of the following components. The cyan ink was prepared only with pigment dispersant 1, the magenta ink was prepared only with pigment dispersant 2, the yellow ink was prepared only with pigment dispersant 3, and the black ink was prepared only with pigment dispersant 4. Thus, the cyan ink, the magenta ink, the yellow ink, and the black ink were created. The remainder for the ion-exchange water refers to an amount with which the sum of all the components included in the ink becomes 100.0 mass %.
pigment dispersant 20.0 mass %
resin particle dispersant 1 24.0 mass %
ethylene urea 7.0 mass %
polyethylene glycol (number-average molecular weight (Mn): 1,000) 1.0 mass %
surface-active agent 0.5 mass %
ion-exchange water remainder

These were sufficiently agitated, dispersed, and after that, subjected to pressure filtering with a microfilter having a pore size of 3.0 μm to prepare the inks.

When ink set b is heated and fixed after the printing with the recording apparatus, water can be substantially completely volatilized, and the water-soluble organic solvent can penetrate into paper. When the water-soluble organic solvent included in ink set b penetrates into the paper, curling and cockling of the paper after the printing can be effectively suppressed.

### Example 7

In example 7, the printing and evaluation were performed under the same conditions as those of example 3 other than that ink set b was used.

### Example 8

In example 8, the printing and evaluation were performed under the same conditions as those of example 4 other than that ink set b was used.

### Example 9

In example 9, the printing and evaluation were performed under the same conditions as those of example 8 other than that the first time was 15 seconds.

### Example 10

In example 10, the reference recording medium was changed from product 8 to an average of five types of recording media. Specifically, average color variation values of product 8, product 10, product 11, product 12, and product 13, all of which fall into the same low-absorbent recording medium category, were used. Other than that, the printing and evaluation were performed under the same conditions as those of example 9.

### Comparative Example 1

In comparative example 1, the printing and evaluation were performed under the same conditions as those of example 9 other than that product 7 was used as reference paper.

### Comparative Example 2

In comparative example 2, the printing and evaluation were performed under the same conditions as those of example 10 other than that product 6 was used as the unregistered recording medium.

### Evaluation

Image samples obtained as described above were evaluated in the following evaluation method. The evaluation results are listed in Table 2. In this evaluation, the L*a*b* color space signal values were checked by the colorimetry, and an average ΔE of 100 patches and the maximum ΔE out of 100 patches were calculated for the case of the target colors and the colors without correction after stabilization of the colors and the case of the target colors and the colors with correction using the color conversion table after stabilization of the colors. Calculation of ΔE was performed in accordance with the above-described color difference formula CIE 2000.

TABLE 2

| | Recording Medium | | | | | | Refer- | | | | | | |
|---|---|---|---|---|---|---|---|---|---|---|---|---|---|
| | | | | Water | | | ence | Average ΔE₀₀ of | | Maximum ΔE₀₀ of | | | |
| | | Basis | | absorbing | | First | record- | 100 patches | | 100 patches | | Evaluation | |
| Ex- | Product | weight | | amount* | Ink | Time | ing | Un- | After | Un- | After | Corrected | Correction |
| ample | name | [g/m²] | Category | [mL/m²] | set | [min] | medium | corrected | correction | corrected | correction | value | effect |
| Ex- | Product | 81 | Absorbent | 16 | a | 10 | Product | 0.39 | 0.19 | 0.63 | 0.48 | S | B |
| ample | 1 | | recording | | | | 7 | | | | | | |
| 1 | | | medium | | | | | | | | | | |
| Ex- | Product | 350 | Absorbent | 20 | a | 10 | Product | 0.49 | 0.24 | 1.05 | 0.62 | A | B |
| ample | 2 | | recording | | | | 7 | | | | | | |
| 2 | Card- | | medium | | | | | | | | | | |
| | board | | | | | | | | | | | | |
| Ex- | Product | 350 | Low- | 8 | a | 10 | Product | 0.57 | 0.23 | 1.38 | 0.71 | A | A |
| ample | 3 | | absorbent | | | | 8 | | | | | | |
| 3 | | | recording | | | | | | | | | | |
| | | | medium | | | | | | | | | | |
| Ex- | Product | 90 | Low- | 5 | a | 10 | Product | 0.61 | 0.33 | 1.27 | 0.79 | A | A |
| ample | 4 | | absorbent | | | | 8 | | | | | | |
| 4 | | | recording | | | | | | | | | | |
| | | | medium | | | | | | | | | | |
| Ex- | Product | 90 | Non- | 2 | a | 10 | Product | 0.53 | 0.34 | 1.03 | 0.74 | A | B |
| ample | 5 | | absorbent | | | | 9 | | | | | | |
| 5 | | | recording | | | | | | | | | | |
| | | | medium | | | | | | | | | | |
| Ex- | Product | | Absorbent | 16 | b | 10 | Product | 0.34 | 0.31 | 0.64 | 0.53 | S | B |
| ample | 1 | | recording | | | | 7 | | | | | | |
| 6 | | | medium | | | | | | | | | | |
| Ex- | Product | 350 | Low- | 8 | b | 10 | Product | 0.87 | 0.48 | 2.55 | 1.02 | B | S |
| ample | 3 | | absorbent | | | | 8 | | | | | | |
| 7 | | | recording | | | | | | | | | | |
| | | | medium | | | | | | | | | | |
| Ex- | Product | 90 | Low- | 5 | b | 10 | Product | 0.75 | 0.31 | 2.26 | 0.67 | A | S |
| ample | 4 | | absorbent | | | | 8 | | | | | | |
| 8 | | | recording | | | | | | | | | | |
| | | | medium | | | | | | | | | | |
| Ex- | Product | 90 | Low- | 5 | b | 1 | Product | 0.94 | 0.32 | 2.91 | 0.58 | A | S |
| ample | 4 | | absorbent | | | | 8 | | | | | | |
| 9 | | | recording | | | | | | | | | | |
| | | | medium | | | | | | | | | | |
| Ex- | Product | 90 | Low- | 5 | b | 1 | Average | 0.94 | 0.25 | 2.91 | 0.51 | S | S |
| ample | 4 | | absorbent | | | | of | | | | | | |
| 10 | | | recording | | | | 5 types | | | | | | |
| | | | medium | | | | | | | | | | |
| Com- | Product | 90 | Low- | 5 | b | 1 | Product | 0.94 | 1.23 | 2.91 | 4.01 | C | C |
| parative | 4 | | absorbent | | | | 7 | | | | | | |
| ex- | | | recording | | | | | | | | | | |
| ample | | | medium | | | | | | | | | | |
| 1 | | | | | | | | | | | | | |
| Com- | Product | 118 | Low- | 8 | b | 1 | Average | 0.84 | 1.21 | 2.56 | 4.01 | C | C |
| parative | 6 | | absorbent | | | | of | | | | | | |
| ex- | | | recording | | | | 5 types | | | | | | |
| ample | | | medium | | | | | | | | | | |
| 2 | | | | | | | | | | | | | |

### Evaluation Criteria

In the present examples, when both the average ΔE range and the maximum ΔE range described below are satisfied, an evaluation on the left side is determined. Regarding evaluation criteria, S to B are desired levels and C is an unacceptable level.

### Corrected Value

S: average ΔE<0.3, maximum ΔE<0.6
A: average ΔE<0.5, maximum ΔE<1.0
B: average ΔE<0.8, maximum ΔE<1.5
C: average ΔE>0.8, maximum ΔE>1.5

### Correction Effect

Correction rate=Maximum ΔE with correction/Maximum ΔE without correction
S: correction rate<0.3
A: correction rate<0.6
B: correction rate<1.0
C: correction rate>1.0

In examples 1 and 2, product 7 was used as the reference paper in color correction in the absorbent recording medium. In example 1, a high correction effect in which the average ΔE after correction is 0.19 was produced. In example 2, when the correction was executed with product 2, although it was not as favorable as correction with thin paper in example 1, sufficient correction was able to be performed.

Color correction is performed with the low-absorbent recording medium in examples 3 and 4 and the non-absorbent recording medium in example 5. In each of the examples, the evaluation of the corrected value is A. In examples 6 to 10, the ink set was changed to ink set b of a non-volatile solvent type to perform the correction. From the results of examples 6 to 8, the color correction was able to be performed with both the absorbent recording medium and the low-absorbent recording medium. In particular, with the low-absorbent recording medium on examples 7 and 8, the maximum ΔE was changed from 2.55 to 1.02 and 2.26 to 0.67. Thus, the correction was able to be performed with a higher correction effect than that with ink a of a volatile solvent type. When the first time was changed to 15 seconds in example 9, the maximum ΔE was changed from 2.91 to 0.58. Thus, the correction was able to be performed with a higher correction effect than that of example 8 where the first time is 10 minutes. In example 10, the reference recording medium was changed to the average of five types. As a result, the corrected value was improved compared to that with a single reference recording medium in example 9. Meanwhile, in comparative example 1, the correction was attempted by using the reference paper of a different recording medium type. However, because of a different color variation tendency, ΔE was degraded compared to that before the correction. When the category of the unregistered recording medium and the category of the reference recording medium do not match each other, the correction effect was not obtained because of the difference in color variation amount. In comparative example 2, a recording medium with a reformed surface layer for electrophotography was used. However, in this case, because of the difference in color variation tendency from the reference recording medium, the correction effect was not obtained, either.

From the above description, execution of the color correction for which the time-dependent color variation is considered can be realized by creating the color conversion table without long standby time for various recording media.

### Example 11

Japanese Patent Laid-Open No. 2012-199832 discloses a technique in which main components are analyzed from a feature amount of a recording medium to be used to create a look-up table (LUT) of a predetermined recording medium.

Although calibration can be carried out by performing analysis on a recording medium-by-recording medium basis in this method, time taken before printing is long due to creation of a color conversion table.

Thus, according to the present example, an example in which the color correction is executed without newly creating the color conversion table for each type of the recording medium is described.

For simplicity, the description focuses on the difference from the above-described examples. The same elements are denoted by the same reference numerals in the description.

### Borrowing of Color Conversion Table and Image Processing

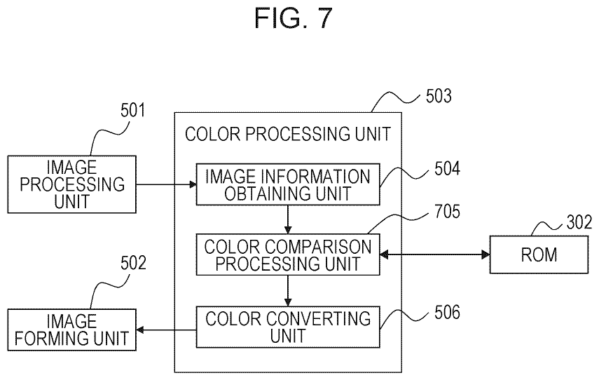

The details of the color correction according to the present example are described with reference to FIG. 7. The color adjustment is performed in the image processing unit 501 in the recording data generating unit 201. The image processing unit 501 performs the color adjustment on YMCK data so that the YMCK data matches target colors to be normally output by the image forming unit 502 corresponding to the YMCK data. This conversion according to the present example is performed by using the color conversion table used to convert the L*a*b* color space information obtained by colorimetry into Y′M′C′K′ data to be output. The color conversion table is used to correct a color mixture by updating a three-dimensional color conversion table used to convert a device independent color space (L*a*b*) into a device dependent color space (CMYK).

Regarding the color conversion table, the color processing unit 503 determines a color conversion table to be borrowed. In the color processing unit 503, the image information obtaining unit 504 obtains the L*a*b* value data of a color chart for recording medium identification printed on the recording medium to be used for the printing immediately after the printing. A color comparison processing unit 705 calculates the ΔE with the L*a*b* values for various recording media recorded on the DB in the ROM 302 immediately after the printing and selects a recording medium with the closest ΔE by comparison. The color converting unit 506 borrows the color conversion table and the printing conditions of the selected recording medium, and the image forming unit 502 converts into the final input values Y′, M′, C′, and K′ of the colors.

### Entire Flow of Borrowing of Printing Conditions

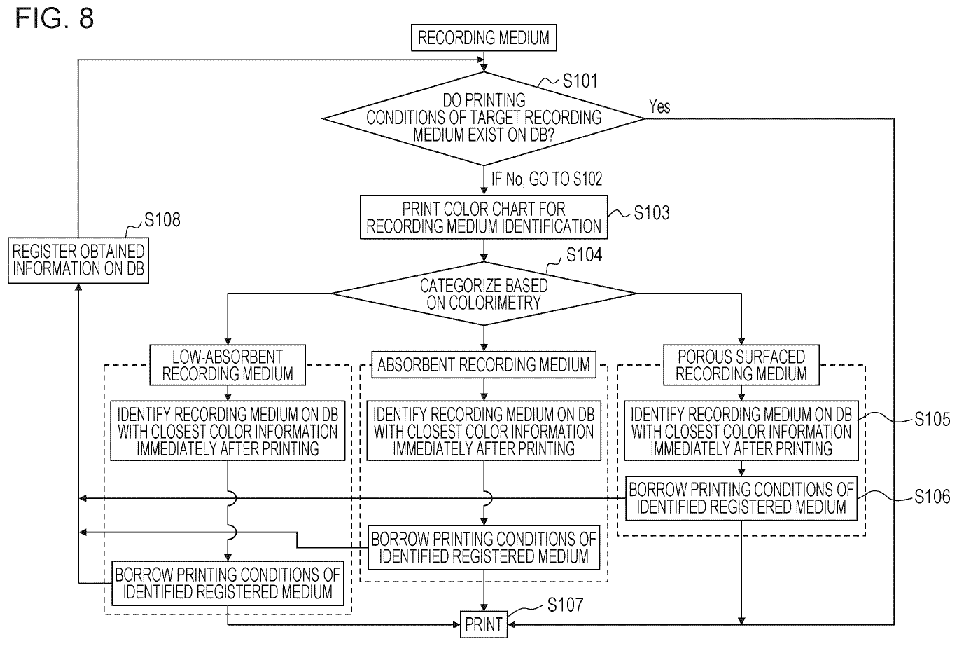

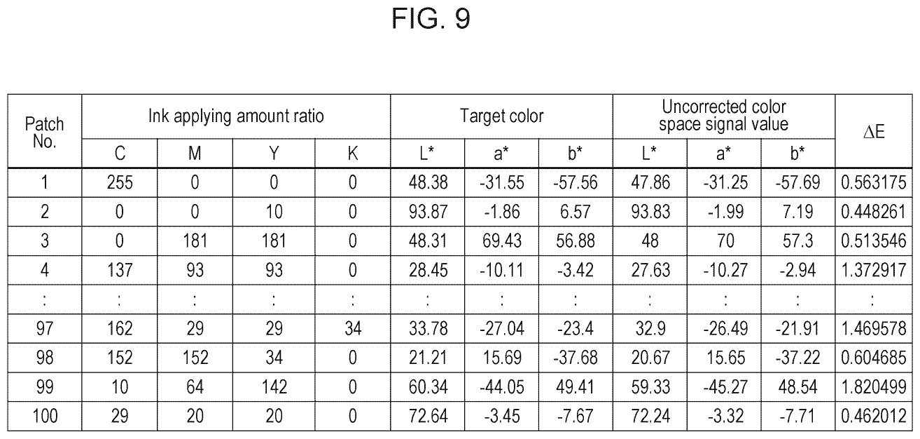

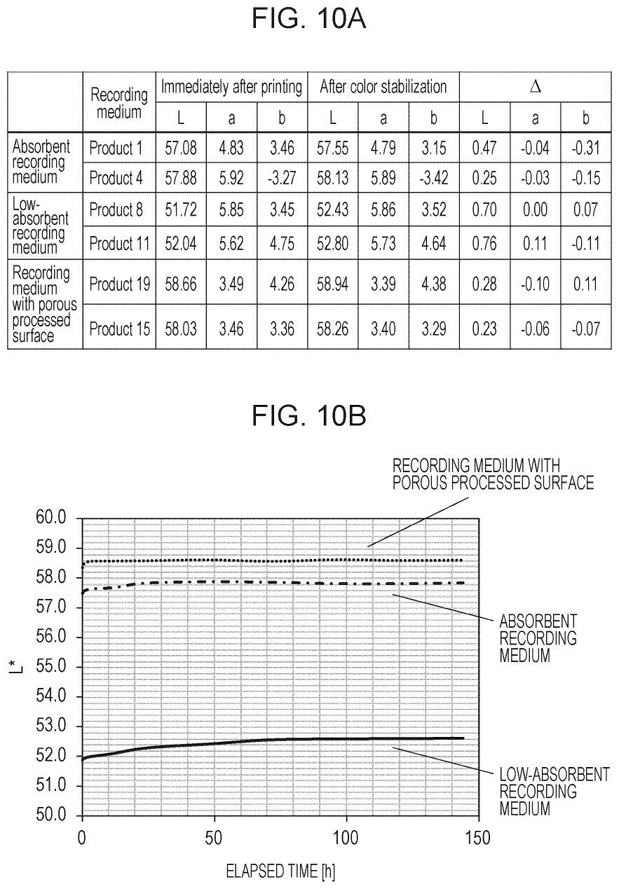

FIG. 8 is a flowchart illustrating a procedure of calibration processing.

In S101, first, with respect to a printing-target recording medium, whether the printing conditions including the color conversion table for the target recording medium exist on the DB of the recording apparatus is checked.

As an example of the comparison, when the user has set, as the printing condition, the name of the printing-target recording medium, whether this name exists on the DB is compared. As a result of the comparison, when the printing conditions exist, printing with application of the printing conditions thereto allows execution of printing which also serves as calibration against color variation.

In S102, as a result of the check in S101, when the printing conditions do not exist, colorimetry data of the color chart for recording medium identification for the printing target is obtained.

In S104, the type of the recording medium is categorized by comparing the colorimetric values of the obtained color chart, immediately after the printing with the L*a*b* values stored on the DB in S103.

In S105, out of the categorized types of recording media, the closest recording medium is identified.

In S106, the printing conditions of the identified registered recording medium are set.

In S107, printing is performed by using correction information included in the set printing conditions. The correction information used here corrects the colorimetric values obtained in S103 to the colors after the passage of the second predetermined time. The second predetermined time is longer than the time having been passed immediately after the printing. The correction information is related to the colorimetric values immediately after the printing and stored on the DB on a recording medium-by-recording medium basis.

In S108, the printing conditions identified in S105 are registered in the DB as a new record.

### Printing Conditions a

The hot-air dryer was used as the hot-air drying unit 104 that heats the ink for drying, and ink applying amounts and drying conditions were set so that the surface temperature of the recording medium 101 became a predetermined temperature. The reaction liquid applied by the reaction liquid applying unit 102 was prepared as described above, and the application amount was set to 2 g/m². As the ink applying unit 103, the inkjet head of a type in which the electrothermal transducer is used and with which the ink is discharged in the on-demand method was used. The ink application amount was set to 24 g/m².

The surface temperature of the recording medium was measured by using the radiation thermometer. The fixing belt that can be heated with the halogen heater from thereinside was used as the fixing unit 105. The surface temperature of the fixing unit 105 immediately before the contact with the recording medium 101 was set to a predetermined temperature. The PTFE material was used for the fixing member to be brought into contact with the recording medium. Fixing was performed at a temperature of 90° C. and a fixing pressure of 200 Pa. Regarding the temperature of the fixing member, the surface temperature of the fixing member was measured by using the radiation thermometer.

Under the above-described printing conditions, the above-described color chart for recording medium identification was printed on various types of A3 recording media 101.

### Identification of Recording Medium Type

Colorimetry was performed one minute after the printing on the printed color chart, and the color space signal values L*a*b* are obtained. The colorimetry was performed under the following conditions by using the fluorescent spectrodensitometer.

### Colorimetric Conditions

Measurement environments: 25° C., 50%
Measurement method: Reflection measurement
Illumination conditions: M1 (D50)
Observation field of view: 2°
Observation light source: D50
Polarizing filter: Not mounted

The L*a*b* values of the colors of the color chart having been subjected to the colorimetry were compared with the L*a*b* values of the colors measured one minute after the printing for the reference recording media on the DB having been checked in advance. A recording medium on the DB with the closest ΔE was selected. As the recording media on the DB, 18 types of recording media including absorbent recording media and non-absorbent recording media having different surface properties were prepared in advance.

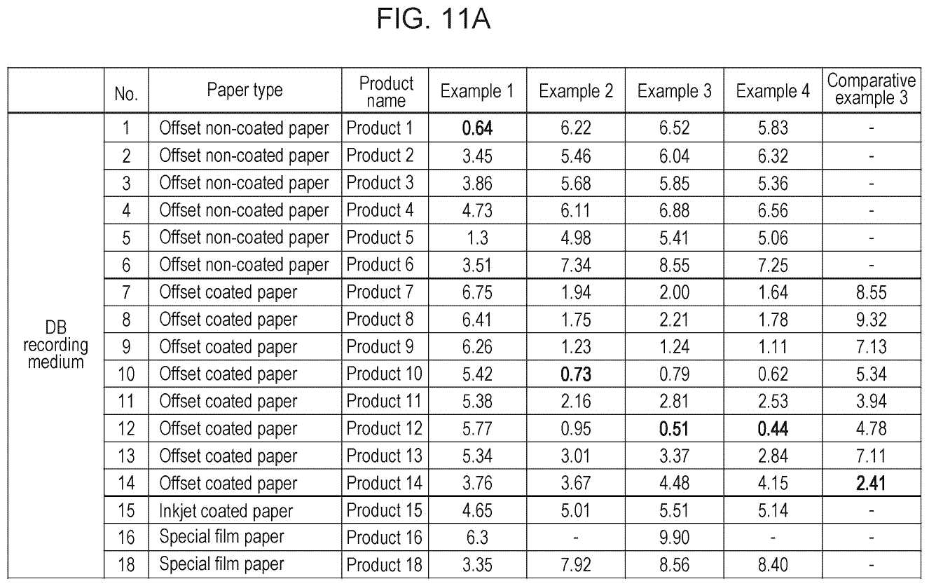

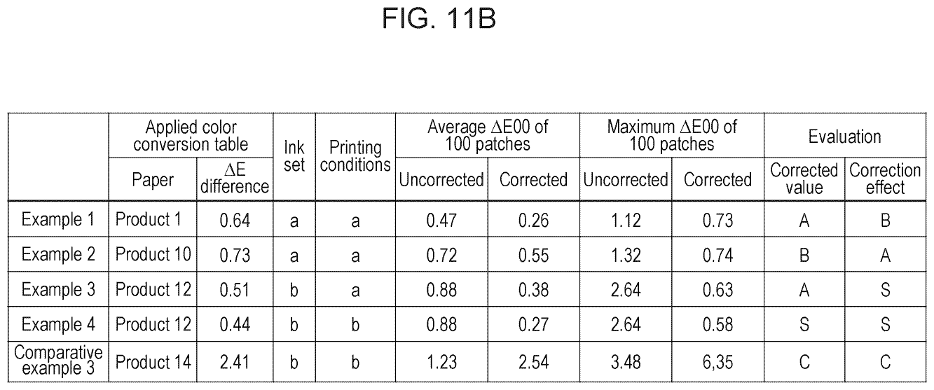

FIG. 11A illustrates results of comparison in L*a*b* values between the recording media of the examples and the recording media on the DB. Since a ΔE exceeding 10 is at a level unworthy of comparison, no value is listed (filled with a dash).

### Printing of Evaluation Chart

In the present example, the above-described color chart for recording medium type identification was printed. Printing was performed under the same printing conditions as the above-described Printing Conditions.

### Preparation of Ink Set a

Components (unit: %) described below were mixed to prepared the cyan, magenta, yellow, and black inks. Resin particle dispersant 1 and pigment dispersants 1 to 4 obtained above were mixed with each of the following components. The cyan ink was prepared only with pigment dispersant 1, the magenta ink was prepared only with pigment dispersant 2, the yellow ink was prepared only with pigment dispersant 3, and the black ink was prepared only with pigment dispersant 4. Thus, the cyan ink, the magenta ink, the yellow ink, and the black ink were created. The remainder for the ion-exchange water refers to an amount with which the sum of all the components included in the ink becomes 100.0 mass %.

| | |
|---|---|
| pigment dispersant | 20.0 mass % |
| resin particle dispersant 1 | 24.0 mass % |
| ethylene glycol | 7.0 mass % |
| surface-active agent | 0.5 mass % |
| ion-exchange water | remainder |

These were sufficiently agitated, dispersed, and after that, subjected to pressure filtering with a microfilter having a pore size of 3.0 μm to prepare the inks.

When ink set a is heated and fixed after the printing with the recording apparatus according to the present disclosure, water and a water-soluble organic solvent in the ink layer can be substantially completely volatilized. Although ink set a can be used for printing on a sheet of a paper substrate, a non-absorbent film, and the like, printing on the sheet of a paper substrate with ink set a tends to be less effective in suppressing curling or cockling than with ink set b, which will be described later.

In example 11, offset non-coated paper was used as the unregistered recording medium. In FIG. 11A, comparison with the recording media on the DB was performed, and product 1 (ΔE=0.64) was selected as a recording medium with the closest average ΔE. The evaluation chart was printed by borrowing and applying the color conversion table of OK prince high-quality paper.

### Example 12

In example 12, offset coated paper was used as the unregistered recording medium. As the color conversion table to be borrowed, from FIG. 11A, product 10 was applied to print the evaluation chart. The printing and evaluation were performed under the same conditions as those of example 1 other than the above description.

### Example 13

In example 13, the inks prepared as follows (ink set b) were used. As the color conversion table to be borrowed, from FIG. 11A, product 12 was applied to print the evaluation chart. The printing and evaluation were performed under the same conditions as those of example 12 other than the above description.

### Preparation of Ink Set b

Components (unit: %) described below were mixed to prepared the cyan, magenta, yellow, and black inks.

Resin particle dispersant 1 and pigment dispersants 1 to 4 described above were mixed with each of the following components. The cyan ink was prepared only with pigment dispersant 1, the magenta ink was prepared only with pigment dispersant 2, the yellow ink was prepared only with pigment dispersant 3, and the black ink was prepared only with pigment dispersant 4. Thus, the cyan ink, the magenta ink, the yellow ink, and the black ink were created. The remainder for the ion-exchange water refers to an amount with which the sum of all the components included in the ink becomes 100.0 mass %.

| | |
|---|---|
| pigment dispersant | 20.0 mass % |
| resin particle dispersant 1 | 24.0 mass % |
| ethylene urea | 7.0 mass % |
| polyethylene glycol (number-average molecular | 1.0 mass % |
| weight (Mn): 1,000) | |
| surface-active agent | 0.5 mass % |
| ion-exchange water | remainder |

These were sufficiently agitated, dispersed, and after that, subjected to pressure filtering with a microfilter having a pore size of 3.0 μm to prepare the inks.

When ink set b is heated and fixed after the printing with the recording apparatus, water can be substantially completely volatilized, and the water-soluble organic solvent can penetrate into paper. When the water-soluble organic solvent included in ink set b penetrates into the paper, curling and cockling of the paper after the printing can be effectively suppressed.

### Example 14

In example 14, the following conditions (printing conditions b) were used as the printing conditions. The printing and evaluation were performed under the same conditions as those of example 13 other than the above description.

### Printing Conditions b

The hot-air dryer was used as the hot-air drying unit 104 that heats the ink for drying and set so that the surface temperature of the recording medium 101 became a predetermined temperature. The reaction liquid applied by the reaction liquid applying unit 102 was prepared as described above, and the application amount was set to 1 g/m². As the ink applying unit 103, the inkjet head of a type in which the electrothermal transducer is used and with which the ink is discharged in the on-demand method was used. The ink application amount was set to 18 g/m².

The surface temperature of the recording medium was measured by using the radiation thermometer. The fixing belt that can be heated with the halogen heater from thereinside was used as the fixing unit 105. The surface temperature of the fixing unit 105 immediately before the contact with the recording medium 101 was set to a predetermined temperature. The PTFE material was used for the fixing member to be brought into contact with the recording medium. Fixing was performed at a temperature of 90° C. and a fixing pressure of 200 Pa. Regarding the temperature of the fixing member, the surface temperature of the fixing member was measured by using the radiation thermometer.

### Comparative Example 3

In comparative example 3, offset coated paper was used as the unregistered recording medium. As the color conversion table to be borrowed, from FIG. 11A, product 14 was applied to print the evaluation chart. The printing and evaluation were performed under the same conditions as those of example 13 other than the above description.

### Evaluation

Image samples obtained in the above-described examples were evaluated in the following evaluation method. The evaluation results are listed in FIG. 11B. In this evaluation, the L*a*b* color space signal values were checked by the colorimetry, and an average ΔE of 100 patches and the maximum ΔE out of 100 patches were calculated for the case of the target colors and the colors without correction after stabilization of the colors and the case of the target colors and the colors with correction after stabilization of the colors. Calculation of ΔE was performed in accordance with the above-described color difference formula CIE 2000.

### Evaluation Criteria

In the present examples, when both the average ΔE range and the maximum ΔE range described below are satisfied, an evaluation on the left side is determined. Regarding evaluation criteria, S to B are desired levels and C is an unacceptable level.

### Corrected Value

S: average ΔE<0.3, maximum ΔE<0.6
A: average ΔE<0.5, maximum ΔE<1.0
B: average ΔE<0.8, maximum ΔE<1.5
C: average ΔE>0.8, maximum ΔE>1.5

### Correction Effect

Correction rate=Maximum ΔE with correction/Maximum ΔE without correction
S: correction rate<0.3
A: correction rate<0.6
B: correction rate<1.0
C: correction rate>1.0

In example 11, borrowing of the printing conditions was carried out with offset non-coated paper as the example of the absorbent recording medium. Although the effect of the color correction with the absorbent recording medium, which originally exhibits small time-dependent color variation, is small, regarding the corrected values, the average ΔE can be corrected from 0.47 to 0.26 and the maximum ΔE can be corrected from 1.12 to 0.73. In example 12, borrowing of the printing conditions was carried out with offset coated paper as the example of the low-absorbent recording medium. Although ΔE after the correction is slightly higher than that of the absorbent recording medium, the correction can be carried out with a desired correction effect. In example 13, the ink was changed to the ink (ink set b) including the water-soluble organic solvent with a boiling point of higher than or equal to 250° C. Since the water-soluble organic solvent with a high boiling point causes remaining in the paper as described above, the time-dependent color variation is large. In particular, although the variation takes longer time in the low-absorbent recording medium, as indicated by the present example, the correction can be performed by borrowing the printing conditions of a recording medium on the DB with the closest color variation tendency. Regarding the corrected values, the average ΔE is corrected from 0.88 to 0.38 and the maximum ΔE is corrected from 2.64 to 0.63. Thus, as a result, the correction effect is higher than that with the ink set used in examples 11 and 12. In example 14, the printing conditions were changed to printing conditions b optimized for the non-absorbent recording medium. As a result, more desired correction values and correction effect can be obtained than with the printing conditions a. In each example, the average ΔE after the correction tends to be a value close to ΔE with the recording medium which has been selected for the borrowing by the comparison immediately after the printing for paper type identification.

In contrast, comparative example 3 is an example with special offset coated paper having the surface reformed for electrophotography.

Even for offset coated paper, when offset coated paper with the close initial L*a*b* values does not exist on the DB, the color correction cannot be accurately carried out. Thus, the printing conditions cannot be borrowed. This case can be accommodated by increasing variations of the recording medium types on the DB.

Thus, execution of the color correction can be realized without newly creating the color conversion table for each type of the recording medium.

The present disclosure can be realized by the following processing: a program configured to realize one or more functions of the above-described embodiment is supplied to a system or an apparatus via a network or a storage medium; and one or more processors in a computer of the system or the apparatus read and execute the program. Alternatively, the present disclosure can be realized by using a circuit (e.g., an ACIC) configured to realize the one or more functions.

According to the present disclosure, calibration for which time-dependent color variation is considered can be performed without taking a long time.

### Other Embodiments

The embodiment of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of the above-described embodiment and/or that includes one or more circuits (e.g., application specific integrated circuit (ASIC)) for performing the functions of the above-described embodiment, and by a method performed by the computer of the system or apparatus by, for example, reading out and executing the computer executable instructions from the storage medium to perform the functions of the above-described embodiment and/or controlling the one or more circuits to perform the functions of the above-described embodiment. The computer may comprise one or more processors (e.g., a CPU, a micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a RAM, a ROM, a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2023-123788, filed Jul. 28, 2023 and No. 2023-140543, filed Aug. 30, 2023, which are hereby incorporated by reference herein in their entirety.

What is claimed is:

1. An image processing apparatus comprising:
one or more circuits; or
one or more processors and at least one memory, the at least one memory being coupled to the one or more processors and having stored thereon instructions executable by the one or more processors, wherein at least one of the one or more circuits or the execution of the instructions causes the image processing apparatus to function as:
an input unit configured to input image data; and
a color conversion unit configured to, based on a time-dependent color variation characteristic of a printed image in a first recording medium, perform color conversion on the image data corresponding to time-dependent color variation of a second recording medium.

2. The image processing apparatus according to claim 1,
wherein the time-dependent color variation characteristic is a color variation characteristic from a first time before a color printed on the first recording medium is stabilized to a second time after the color has been stabilized.

3. The image processing apparatus according to claim 2, wherein execution of the stored instructions further configures the at least one processor to operate as:
a storage unit configured to store a color conversion table used for the color conversion on a recording medium-by-recording medium basis,
wherein the color conversion is performed when the color conversion table that corresponds to a printing condition under which the image data is printed, by using the second recording medium, corresponding to the color variation characteristic to the second time is not stored.

4. The image processing apparatus according to claim 3, further comprising:
an obtaining unit configured to obtain colorimetric information obtained by performing, at the first time, colorimetry on a color chart printed on the second recording medium,
wherein the color conversion unit creates the color conversion table corresponding to the printing condition by adding the time-dependent variation characteristic to the colorimetric information and performs the color conversion by using the created color conversion table.

5. The image processing apparatus according to claim 4,
wherein an image of the color chart is formed by an ink, and the ink includes a water-soluble organic solvent with a boiling point of equal to or higher than 250° C.

6. The image processing apparatus according to claim 2,
wherein the first time is equal to or shorter than one minute from printing.

7. The image processing apparatus according to claim 1,
wherein the second recording medium is a low-absorbent recording medium.

8. The image processing apparatus according to claim 7,
wherein a water absorbing amount of the low-absorbent recording medium is greater than or equal to 4 mL/m² and smaller than or equal to 10 mL/m² from a start of contact to 30 msec^{1/2} in a Bristow method.

9. The image processing apparatus according to claim 1,
wherein the first recording medium and the second recording medium are categorized into an identical category of a recording medium.

10. A color processing apparatus comprising:
one or more circuits; or
one or more processors and at least one memory, the at least one memory being coupled to the one or more processors and having stored thereon instructions executable by the one or more processors, wherein at least one of the one or more circuits or the execution of the instructions causes the image processing apparatus to function as:
an obtaining unit configured to obtain color information of a color chart printed on a first recording medium;
a storage unit configured to store, for a plurality of recording media, color information indicating a color after a first predetermined time has passed, the color being printed on the recording media, and correction information for correcting the color indicated by the color information to a color after a second predetermined time longer than the first predetermined time has passed such that the color information and the correction information are related to each other; and
a processing unit configured to identify target color information to be used for the first recording medium from the stored color information in accordance with the obtained color information and execute printing processing for printing an image on the first recording medium by using the correction information corresponding to the identified target color information.

11. The color processing apparatus according to claim 10,
wherein the processing unit categorizes a type of the first recording medium in accordance with the color information after the first predetermined time has passed and identifies the target color information used for the first recording medium in accordance with the categorized type.

12. The color processing apparatus according to claim 10,
wherein the processing unit uses the correction information corresponding to the identified target color information and executes the printing processing for printing the image on the first recording medium.

13. The color processing apparatus according to claim 10,
wherein the printing processing is performed by using an ink applying amount and a drying condition set in advance in accordance with the categorized type.

14. The color processing apparatus according to claim 10,
wherein the correction information is information that indicates a correspondence between the color indicated by the color information after the first predetermined time has passed and the color indicated by the color information after the second predetermined time has passed.

15. The color processing apparatus according to claim 10,
wherein an image of the color chart is formed by an ink, and the ink includes a water-soluble organic solvent with a boiling point of equal to or higher than 250° C.

16. The color processing apparatus according to claim 10,
wherein the first recording medium is a low-absorbent recording medium.

17. A method for processing an image comprising:
one or more circuits; or
one or more processors and at least one memory, the at least one memory being coupled to the one or more processors and having stored thereon instructions executable by the one or more processors, wherein at least one of the one or more circuits or the execution of the instructions causes the image processing apparatus to function as:
inputting image data; and,
based on a time-dependent color variation characteristic of a printed image in a first recording medium, performing color conversion on the image data corresponding to time-dependent color variation of a second recording medium.

18. A method for processing a color comprising:
one or more circuits; or
one or more processors and at least one memory, the at least one memory being coupled to the one or more processors and having stored thereon instructions executable by the one or more processors, wherein at least one of the one or more circuits or the execution of the instructions causes the image processing apparatus to function as:
obtaining color information of a color chart printed on a first recording medium;
storing, for a plurality of recording media, color information indicating a color after a first predetermined time has passed, the color being printed on the recording media, and correction information for correcting the color indicated by the color information to a color after a second predetermined time longer than the first predetermined time has passed such that the color information and the correction information are related to each other; and
identifying target color information to be used for the first recording medium from the stored color information in accordance with the obtained color information and executing printing processing for printing an image on the first recording medium by using the correction information corresponding to the identified target color information.

19. A non-transitory computer-readable storage medium storing instructions that, when executed by a computer, cause the computer to perform a method comprising:
one or more circuits; or
one or more processors and at least one memory, the at least one memory being coupled to the one or more processors and having stored thereon instructions executable by the one or more processors, wherein at least one of the one or more circuits or the execution of the instructions causes the image processing apparatus to function as:
inputting image data; and,
based on a time-dependent color variation characteristic of a printed image in a first recording medium, performing color conversion on the image data corresponding to time-dependent color variation of a second recording medium.

20. A non-transitory computer-readable storage medium storing instructions that, when executed by a computer, cause the computer to perform a method comprising:
one or more circuits; or
one or more processors and at least one memory, the at least one memory being coupled to the one or more processors and having stored thereon instructions executable by the one or more processors, wherein at least one of the one or more circuits or the execution of the instructions causes the image processing apparatus to function as:
obtaining color information of a color chart printed on a first recording medium;
storing, for a plurality of recording media, color information indicating a color after a first predetermined time has passed, the color being printed on the recording media, and correction information for correcting the color indicated by the color information to a color after a second predetermined time longer than the first predetermined time has passed such that the color information and the correction information are related to each other; and
identifying target color information to be used for the first recording medium from the stored color information in accordance with the obtained color information and executing printing processing for printing an image on the first recording medium by using the correction information corresponding to the identified target color information.
